(19) United States
(12) Patent Application Publication
(10) Pub. No.: US 2025/0158994 A1
(43) Pub. Date: May 15, 2025

(54) SYSTEM OF ACCESS CONTROL BASED ON CONFIDENCE LEVEL OF USER AND USER TERMINAL

(71) Applicant: SGA Solutions Co., Ltd., Seoul (KR)

(72) Inventors: Ki Uk LEE, Seongnam-si (KR); Hyun Jin LEE, Seoul (KR)

(21) Appl. No.: 18/892,446

(22) Filed: Sep. 22, 2024

(30) Foreign Application Priority Data
Nov. 15, 2023 (KR) 10-2023-0157995

(51) Int. Cl. H04L 9/40

(52) U.S. Cl. CPC H04L 63/102; H04L 63/205

(57) ABSTRACT

The present invention relates to a dynamic access control system based on confidence levels of a user and a user terminal, including: an agent installed in the user terminal, and configured to collect a registry generated in the user terminal; a confidence determination machine in which legitimate user information and legitimate user terminal information are registered, configured to perform identity authentication for the user and the user terminal, which request access to an in-house resource management server, and configured to perform verification on state information of the user terminal based on a security policy that is previously distributed to determine a confidence level when the identity authentication for the user and the user terminal is completed; and a terminal management server configured to transmit a registry collection result from the agent to the confidence determination machine as the state information of the user terminal.

### BACKGROUND OF THE INVENTION

### 1. Field of the Invention

The present invention relates to a dynamic access control system based on confidence levels of a user and a user terminal, and more particularly, to a technology for protecting internal resources from threat of attacks by allowing only a legitimate user to access an in-house resource management server by using user information registered in a confidence determination machine, and continuously monitoring confidence levels of a user and a user terminal even after the user accesses the in-house resource management server so as to perform an immediate response when a malicious behavior is detected.

### 2. Description of the Related Art

Due to changes in work environments, which are caused by the spread of various infectious diseases as well as the development of IT, the frequency of working remotely or working from home instead of going to work is increasing. However, workers who perform tasks of handling sensitive information including corporate trade secrets or personal information were unable to work remotely or work from home due to the lack of a proper monitoring scheme against leaks of sensitive information.

Meanwhile, Korean Patent Registration No. 10-2402705 discloses a configuration that performs a verification process of a verification module according to at least one scenario on multi-factor security authentication for mobile remote control in a network separation environment. However, according to the related art described above, there is a limitation that once a user accessing a mobile device has passed the authentication, it is impossible to monitor abnormal signs based on a behavior of the user or prevent illegal leaks. Therefore, there is a growing need for an intelligent security solution capable of monitoring an access environment of a user even after the user has successfully completed security authentication, and performing an immediate response when a malicious behavior is detected.

### SUMMARY OF THE INVENTION

Accordingly, an object of the present invention is to provide a technology for protecting internal resources from threat of attacks by allowing only a legitimate user to access an in-house resource management server by using user information registered in a confidence determination machine, and continuously monitoring confidence levels of a user and a user terminal even after the user accesses the in-house resource management server so as to perform an immediate response when a malicious behavior is detected.

To achieve the above object, according to one embodiment of the present invention, a dynamic access control system based on confidence levels of a user and a user terminal, which is implemented as a computing device including at least one processor and at least one memory for storing instructions that are executable by the processor, includes: an agent installed in the user terminal, and configured to collect a registry generated in the user terminal; a confidence determination machine in which legitimate user information and legitimate user terminal information are registered, configured to perform identity authentication for the user and the user terminal, which request access to an in-house resource management server, and configured to perform verification on state information of the user terminal based on a security policy that is previously distributed to determine a confidence level when the identity authentication for the user and the user terminal is completed; and a terminal management server configured to transmit a registry collection result from the agent to the confidence determination machine as the state information of the user terminal.

In this case, preferably, the confidence determination machine may determine whether to allow the access to the in-house resource management server based on the confidence level determined for the user terminal, such that the access to the in-house resource management server may be allowed when the confidence level determined for the user terminal is greater than or equal to a preset threshold confidence level, and the access to the in-house resource management server may not be allowed when the confidence level determined for the user terminal is less than the preset threshold confidence level.

In addition, preferably, when a request for the access to the in-house resource management server is received again from the user terminal that is not allowed to access the in-house resource management server, the confidence determination machine may determine whether the confidence level of the user terminal has reached the preset threshold confidence level, and may allow the access to the in-house resource management server when the confidence level of the user terminal is determined to be increased to satisfy the threshold confidence level.

In addition, preferably, when at least one access denial history is determined to exist as a result of checking an access history of the user terminal to the resource management server, the confidence determination machine may request additional authentication to the user terminal through an additional authentication server, and may allow the user terminal that has completed the additional authentication to access the in-house resource management server.

In addition, preferably, the confidence determination machine may monitor an operation authorized to the user terminal after the user terminal accesses the in-house resource management server, and may dynamically control access authority to the in-house resource management server by reducing the confidence level of the user, which is predetermined in the user terminal, and expiring an access session to the in-house resource management server when a malicious behavior that violates the security policy is detected from the user terminal as a result of the monitoring.

In addition, preferably, resources managed by the in-house resource management server may have different confidence levels required for access depending on importance of the resources, and the confidence determination machine may determine whether the confidence level determined for the user terminal satisfies a confidence level required for access to one resource managed by the in-house resource management server so as to determine whether to allow the access when a request for the access to the one resource is received from the user terminal.

In addition, preferably, when the confidence level required for the access to the one resource has a higher value than the confidence level determined for the user terminal, the confidence determination machine may not allow the user terminal to access the one resource, and may provide feedback information on a confidence level reduction factor to the user terminal that is not allowed to access the one resource.

According to one embodiment of the present invention, only a user who is determined to be a legitimate user may be allowed to access an in-house resource management server by using user information registered in a confidence determination machine to fundamentally block access of a user and a user terminal, which are not trusted, so that internal resources can be safely protected.

In addition, according to one embodiment of the present invention, unlike most of access control technologies disclosed in the related art that perform access control by verifying confidence levels of a user and a user terminal only at a time of accessing an in-house resource management server, the confidence levels may be continuously monitored to determine whether the user has been maliciously changed or whether a virus infection problem has occurred in the user terminal after accessing the in-house resource management server, so that a security solution that maximizes safety from security threats such as leaks of internal resource can be provided.

In addition, according to one embodiment of the present invention, in case a user who accesses an in-house resource management server unintentionally performs a malicious behavior, when the malicious behavior is detected, a solution for restoring a reduced confidence level of a user may be provided as feedback information, so that an unintentional internal threatener can be prevented from occurring, and a security effect on in-house resources can be further enhanced.

### BRIEF DESCRIPTION OF THE DRAWINGS

FIG. 1 is a block diagram showing a dynamic access control system based on confidence levels of a user and a user terminal according to one embodiment of the present invention.

FIGS. 2 and 3 are workflows of a confidence determination machine according to one embodiment of the present invention.

FIG. 4 shows an example of a result screen obtained as a malicious behavior of a user is detected by the confidence determination machine according to one embodiment of the present invention.

FIG. 5 shows an example of providing feedback information on an inaccessible resource according to one embodiment of the present invention.

FIG. 6 is a view showing an internal configuration of a computing device according to one embodiment of the present invention.

### DETAILED DESCRIPTION OF THE INVENTION

Hereinafter, various embodiments and/or aspects will be disclosed with reference to the drawings. In the following description, for the purpose of description, numerous specific details are forth set in order to facilitate an overall understanding of one or more aspects. However, it will also be appreciated by a person having ordinary skill in the art to which the present invention pertains that such aspect(s) may be practiced without the specific details. The following description and the accompanying drawings will be set forth in detail for specific illustrative aspects among the one or more aspects. However, the aspects are provided for illustrative purposes, some of various schemes based on principles of various aspects may be employed, and descriptions set forth herein are intended to include all the aspects and equivalents thereof.

The terms “embodiment”, “example”, “aspect”, “illustration”, and the like used herein may not be construed as indicating that any aspect or design set forth herein is preferable or advantageous over other aspects or designs.

In addition, it is to be understood that the terms “include” and/or “comprise” indicate the presence of corresponding features and/or elements, but do not preclude the presence or addition of one or more other features, elements, and/or groups thereof.

In addition, although the terms including ordinal numbers such as “first” and “second” may be used to describe various elements, the elements are not limited by the terms. The above terms are used merely for the purpose of distinguishing one element from another element. For example, a first element may be termed as a second element, and similarly, a second element may also be termed as a first element without departing from the scope of the present invention. The term “and/or” includes any combination of a plurality of described relevant items, or one of the described relevant items.

In addition, unless defined otherwise, all terms used in embodiments of the present invention, including technical and scientific terms, have the same meaning as those commonly understood by a person having ordinary skill in the art to which the present invention pertains. Any terms as those defined in generally used dictionaries are to be interpreted to have the meanings consistent with the contextual meanings in the relevant field of art, and are not to be interpreted to have idealistic or excessively formalistic meanings unless explicitly defined in the embodiments of the present invention.

The present invention relates to a system 10 for diagnosing vulnerability of a security environment for a user terminal 1, and more particularly, to a technology for protecting internal resources from threat of attacks by allowing only a legitimate user to access an in-house resource management server by using user information registered in a confidence determination machine, and continuously monitoring confidence levels of a user and a user terminal even after the user accesses the in-house resource management server so as to perform an immediate response when a malicious behavior is detected.

Hereinafter, the present invention for achieving the objects described above will be described in detail with reference to the accompanying drawings, and a plurality of drawings may be simultaneously referenced in order to describe one or more technical features or elements constituting the invention.

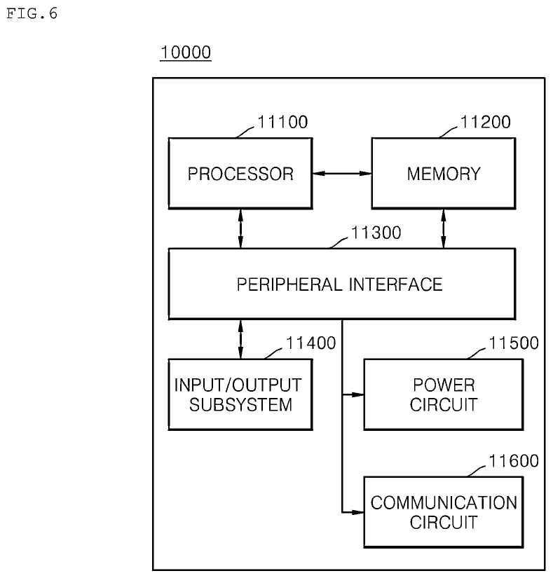

The system 10 according to the present invention may be configured as a computing device as shown in FIG. 6 that will be described below. In other words, the system 10 according to the present invention may be implemented to be included in the computing device of FIG. 6, or at least two computing devices may implemented as a group server system for the implementation of the system 10 according to the present invention.

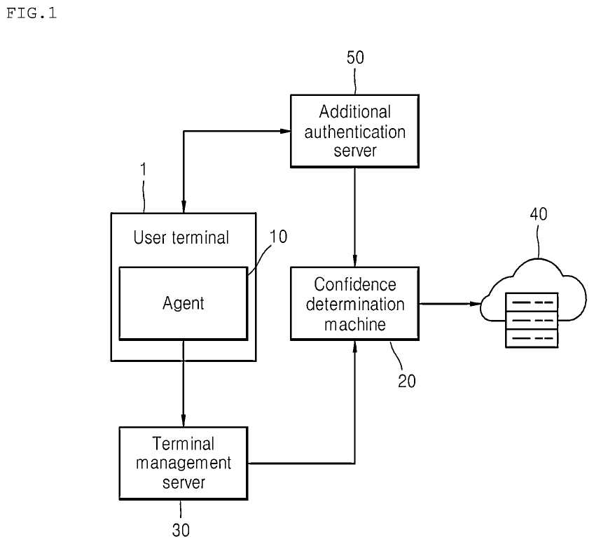

As a description of a dynamic access control system based on confidence levels of a user and a user terminal according to one embodiment of the present invention, referring to FIG. 1, FIG. 1 is a view showing a configuration of the system according to the present invention.

As shown in FIG. 1, the system according to the present invention may include, as main configurations, an agent 10, a confidence determination machine 20, and a terminal management server 30.

In this case, the agent 10 described above may be installed in a user terminal 1, and the agent 10 installed in the user terminal 1 may perform a function of collecting a registry that is previously created in the user terminal 1 and a registry that is newly created in the user terminal 1. The registry described above may refer to a database including system information of all programs operating in an operating system of the user terminal 1, and according to the present invention, the confidence level of the user terminal 1 may be determined through the registry collected as described above.

In addition, the confidence determination machine 20 described in the present invention may be configured such that legitimate user information and legitimate user terminal (1) information are registered, and may perform identity authentication for the user and the user terminal 1, which request access to an in-house resource management server 40.

According to one embodiment, the identity authentication of the user described above may be performed through an authentication scheme of requesting the user to input an ID and a password of the in-house resource management server 40, which are previously assigned to the user, or requesting the user to input a preset session key, and authentication of the user terminal 1 may be performed through comparison of a unique identification number possessed by the user terminal 1.

In addition, the confidence determination machine 20 described above may perform verification on state information of the user terminal 1 based on a security policy that is previously distributed to determine the confidence levels for the user and the user terminal 1 through the verification when the identity authentication for the user and the user terminal 1 is completed.

In this case, the state information of the user terminal 1 may be understood as state information on vulnerability of a security environment, and according to the present invention, the vulnerability of the security environment of the user terminal 1 may be determined by calculating a risk score for each preset scenario that assumes a situation in which the user terminal 1 is attacked by an attacker.

According to the present invention, scenarios used to determine the vulnerability of the security environment may include: a first scenario of calculating a risk score according to an access location of the user terminal 1; a second scenario according to the number of of calculating authentications required for the user terminal 1 when the user terminal 1 attempts to access a resource; a third scenario of calculating a risk score according to a difficulty of an access condition set for a specific resource that the user terminal 1 aims to access; a fourth scenario of calculating a risk score according to a level of access authority granted to the user terminal 1; and a fifth scenario of calculating a risk score according to a level of an impact on confidentiality (a degree of information leaked by an attack), integrity (a degree of information manipulated by the attack), and availability (a degree of a service damaged by the attack) of a resource caused by the attack on the user terminal 1 by an attacker.

To describe an embodiment of a risk score calculation system for each scenario in more detail, in a case of the first scenario described above, after determining whether a network connected to the user terminal 1 is a local network (internal network), an adjacent network (Telnet, FTP restricted network, etc.), or an external network, a lowest risk score among assigned risk scores may be assigned when the network connected to the user terminal 1 is the local network, and a highest risk score among the assigned risk scores may be assigned when the network connected to the user terminal 1 is the external network.

In addition, in a case of the second scenario described above, the risk score may be assigned based on whether additional authentication is required even after the attacker who attacks through the user terminal 1 accesses an in-house network. For example, a lowest risk score among assigned risk scores may be assigned when the authentication of the user terminal 1 is required twice or more, and a highest risk score among the assigned risk scores may be assigned when the authentication of the user terminal 1 is required less than once (i.e., when no additional authentication is required).

In addition, in a case of the third scenario described above, a lowest risk score may be assigned when the difficulty (attack complexity) of the access condition set for the specific resource is high, and a highest risk score may be assigned when the access condition is not set for the specific resource so that the difficulty of the access condition is low. In this case, the difficulty of the access condition may be a measure of complexity of the access condition that has to be solved by the attacker in order to attack the specific resource. According to one embodiment, the access condition may be understood as being set to be solved by a professional hacker when the difficulty of the access condition is high, and the access condition may be understood as being set to be accessible to anyone or accessible by an automated tool when the difficulty of the access condition is low.

In addition, in a case of the fourth scenario described above, a lowest risk score among assigned risk scores may be assigned because damage from the attack may be extremely small when access authority for resources managed in the in-house network is not granted to the user terminal 1, and a highest risk score among the assigned risk scores may be assigned because access to all resources managed in the in-house network is possible when the access authority granted to the user terminal 1 is root authority.

In addition, in a case of the fifth scenario described above, upon calculating the risk scores for the confidentiality, the integrity, and the availability, a lowest risk score among assigned risk scores may be assigned when a degree of the impact of the attack on the resource is expected to be none or extremely small, and a highest score among the assigned risk scores may be assigned when the resource is expected to be completely exposed to an outside or completely damaged by the attack.

Meanwhile, the terminal management server 30 described above may perform m a function of transmitting a registry collection result from the agent 10 to the confidence determination machine 20 as the state information of the user terminal 1, and when the verification is performed on the state information of the user terminal 1 by using the scenarios described above, the confidence determination machine 20 according to the present invention may determine the confidence level based on the risk score obtained by the user terminal 1 in an attack situation for each scenario.

According to one embodiment, as a result of performing the verification on the state information of the user terminal 1, the confidence level may be determined such that a lowest confidence level, which is Level 9, may be assigned because a risk of attack may be high when all risk scores obtained in risk situations for each scenario are significantly higher than a preset reference score, and a highest confidence level, which is Level 1, may be assigned because the risk of attack may be low when all the risk scores obtained in the risk situations for each scenario are significantly lower than the preset reference score.

In addition, in addition to the embodiment described above, according to the present invention, a score interval criterion for classifying confidence levels, which are Level 1 to Level 9, may be set for each scenario, a confidence level for each scenario may be determined according to the risk score obtained by the user terminal 1, and an average value of the determined confidence level for each scenario may be utilized as a final confidence level determined for the user terminal 1.

Meanwhile, according to the embodiment described above, the score interval criterion set for classifying the confidence level for each scenario may all be the same criterion, or a weight may be added to a scenario set as an important scenario by a security manager to apply a criterion in determining the confidence level.

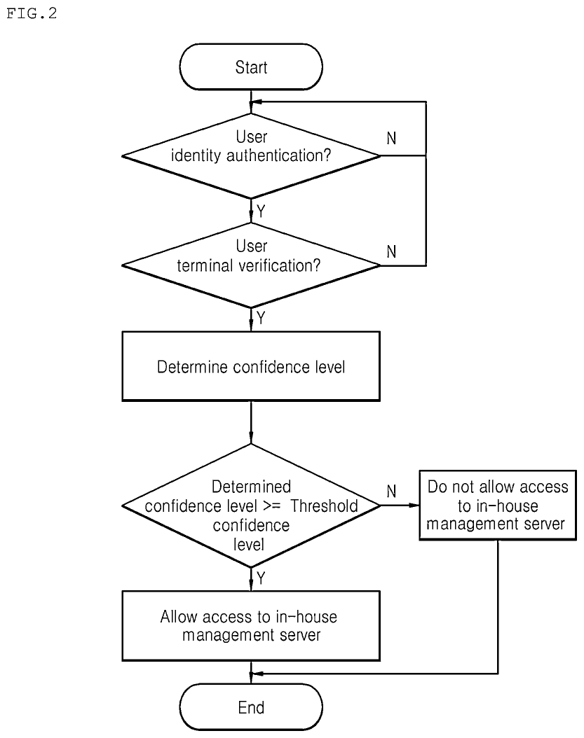

Meanwhile, the confidence determination machine 20 according to the present invention, which performs the above function, may determine whether to allow the access to the in-house resource management server 40 based on the confidence level determined for the user terminal 1, and a flowchart for this operation is shown in FIG. 2.

In this case, the confidence determination machine 20 may control the access to the in-house resource management server 40 by allowing the access to the in-house resource management server 40 when the confidence level determined for the user terminal 1 is greater than or equal to a preset threshold confidence level, and not allowing the access to the in-house resource management server 40 when the confidence level determined for the user terminal 1 is less than the preset confidence level.

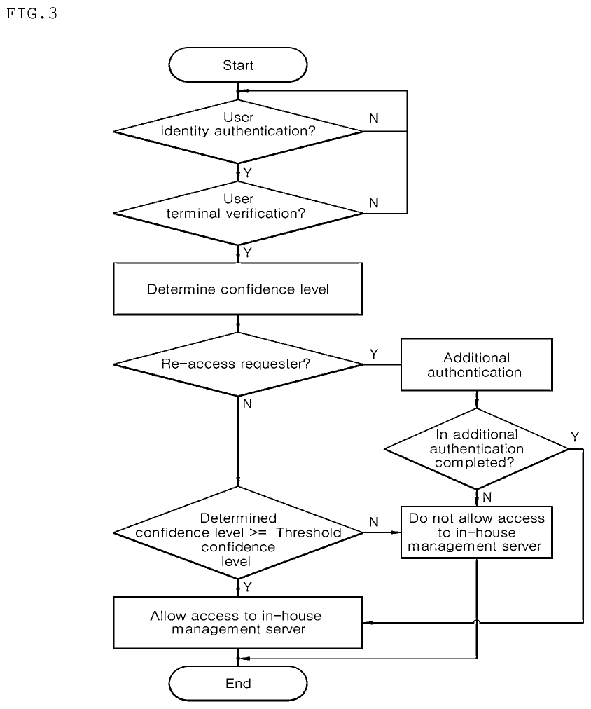

Meanwhile, the confidence determination machine 20 described above may have a flowchart as in FIG. 3 when a request for the access to the in-house resource management server 40 is received again from the user terminal 1 that is not allowed to access the in-house resource management server 40. In other words, the confidence determination machine 20 may determine whether the confidence level of the user terminal 1 has reached the preset threshold confidence level, and may allow the access to the in-house resource management server 40 when the confidence level of the user terminal 1 is determined to satisfy the threshold confidence level by taking an action on the confidence level of the user terminal 1.

Meanwhile, according to another embodiment of the present invention, the confidence determination machine 20 described above may manage a history of the user terminal 1 that is not allowed to access, so that when at least one access denial history is determined to exist as a result of checking an access history of the user terminal 1 accessing the in-house resource management server 40, the confidence determination machine 20 may request additional authentication to the user terminal 1 through an additional authentication server 50.

In this case, the additional authentication server 50 may request authentication using an ID and a password, which are previously assigned to the user terminal 1, or may request authentication including at least one of public certificate, token, phone, and text authentications to determine whether the user is a legitimate user, and the additional authentication server 50 may strengthen access control for a user with at least one access denial history by allowing the user terminal 1 to access the in-house resource management server 40 only after the additional authentication is completed.

According to still another embodiment, the additional authentication server 50 may vary the number of additional authentications requested to the user terminal 1 based on an access denial history number and an access denial history frequency. For example, while one additional authentication may be performed in a case of a user in which the access denial history number is 1, at least two additional authentications may be performed in a case of a user in which the access denial history number is 3 in the past month. Accordingly, in a case of a user in which the access denial history number is large or the access denial history frequency is high, the additional authentication may be performed by using at least two authentication schemes so as to raise an access criterion to the in-house resource management server 40.

In addition, the confidence determination machine 20 according to the present invention may monitor the confidence level for the user terminal 1 even after the user terminal 1 accesses the in-house resource management server 40 in addition to a time at which the user terminal 1 attempts to access the in-house resource management server 40.

In detail, the confidence determination machine 20 may monitor whether the user terminal 1 that has accessed the in-house resource management server 40 performs an operation authorized by the security policy, and may take a measure against a malicious behavior when the malicious behavior that violates the security policy is detected from the user terminal 1 as a result of the monitoring.

In this case, the malicious behavior described above may include intentional or unintentional behaviors, and may include, for example, case in which an abnormality is detected in a security state of the user terminal 1, a case in which a behavior that violates a designated policy such as an IP, a GPS, or a time is detected, a case in which a behavior of changing information of the user and the user terminal 1 is detected, and the like.

When the malicious behavior as described above is detected, the confidence determination machine 20 according to the present invention may dynamically control access authority to the in-house resource management server 40 by reducing the confidence level of the user, which is predetermined in the user terminal 1, and expiring an access session to the in-house resource management server 40.

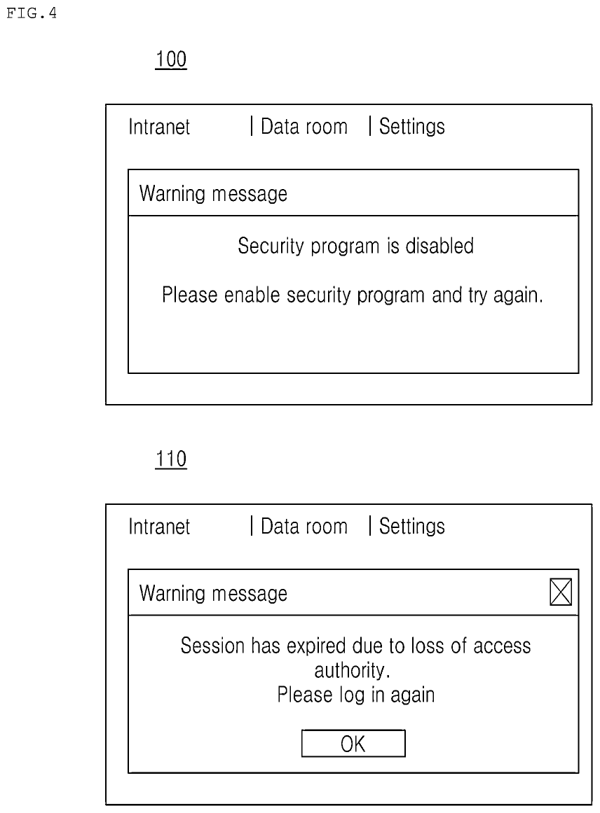

According to one embodiment, referring to FIG. 4, 100 of FIG. 4 shows an example in which a security program is inactivated on the user terminal 1 so that the confidence determination machine 20 detects an abnormality in a security state of the user terminal 1 and provides a warning message to the user terminal 1.

In this case, the confidence determination machine 20 may restore the reduced confidence level of the user when the security state of the user terminal 1 is restored to an original state thereof (i.e., when the security program is reactivated) within a threshold time limit. However, when no other action is taken within the threshold time limit, as shown in 110 of FIG. 4, a user who is not trusted may be blocked by expiring a session of the user terminal 1 that has accessed the in-house resource management server 40.

Meanwhile, resources managed by the in-house resource management server 40 described in the present invention may have different confidence levels required for access depending on importance of the resources.

Accordingly, the confidence determination machine 20 according to the present invention may determine whether the confidence level determined for the user terminal 1 satisfies a confidence level required for access to one resource managed by the in-house resource management server 40 so as to determine whether to allow the access when a request for the access to the one resource is received from the user terminal 1.

In this case, the confidence level required for the access to the one resource will be understood as a separate concept from the confidence level required for the access to the in-house resource management server 40, so that even when the user terminal 1 has succeeded in accessing the in-house resource management server 40, when a resource that requires a confidence level that is higher than the confidence level determined for the user terminal 1 exists in the in-house resource management server 40, the user terminal 1 may not be allowed to access the resource.

However, according to an exemplary embodiment of the present invention, when the confidence level required for the access to the one resource has a higher value than the confidence level determined for the user terminal 1, the confidence determination machine 20 according to the present invention may not allow the user terminal 1 to access the one resource, and may provide feedback information on a confidence level reduction factor to the user terminal 1 that is not allowed to access the one resource.

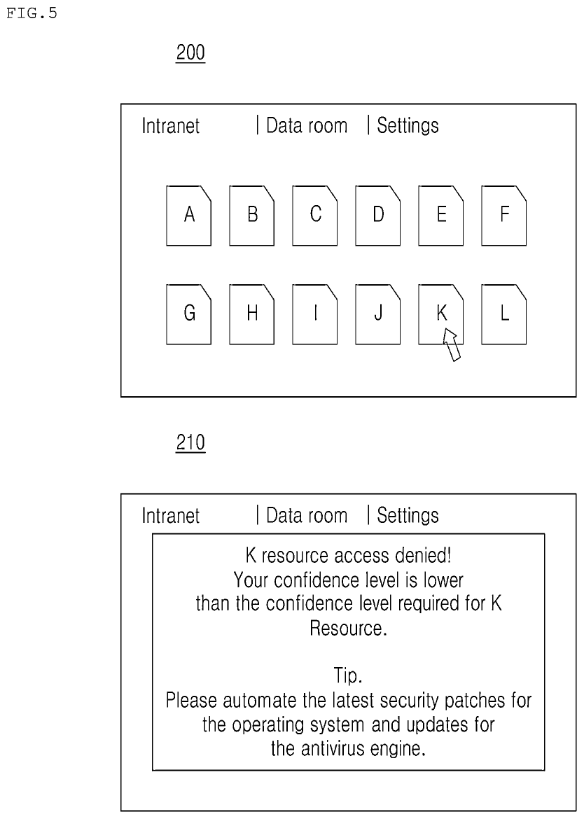

Referring to FIG. 5 as a more specific embodiment, 200 of FIG. 5 shows an embodiment in which the user terminal 1 that has accessed the in-house resource management server 40 requests the access to the one resource (i.e., a K resource shown in the embodiment in 200 of FIG. 5) managed in a database of the in-house resource management server 40.

In this case, the confidence determination machine 20 may compare the confidence level required for the one resource to which the access is requested with the confidence level of the user terminal 1 so as to allow the access when the confidence level of the user terminal 1 is greater than or equal to the confidence level required for the one resource and so as not to allow the access when the confidence level of the user terminal 1 is less than the confidence level required for the one resource, and may provide a guidance message such as 210 of FIG. 5 and the feedback information on the confidence level reduction factor described above.

Meanwhile, the feedback information shown in the embodiment in 210 of FIG. 5 may be understood as feedback information provided when the confidence level is reduced due to security vulnerability caused by the confidence level reduction factor of the user terminal 1, which is latest patches that are not applied to an operating system and a vaccine engine, and different feedback information may be provided depending on the state information (i.e., the security state) of the user terminal 1.

Overall, according to one embodiment of the present invention, only a user who is determined to be a legitimate user may be allowed to access an in-house resource management server 40 by using user information registered in a confidence determination machine 20 to fundamentally block access of a user and a user terminal 1, which are not trusted, so that internal resources may be safely protected.

In addition, according to one embodiment of the present invention, unlike most of access control technologies disclosed in the related art that perform access control by verifying confidence levels of a user and a user terminal 1 only at a time of accessing an in-house resource management server 40, the confidence levels may be continuously monitored to determine whether the user has been maliciously changed or whether a virus infection problem has occurred in the user terminal 1 after accessing the in-house resource management server, so that a security solution that maximizes safety from security threats such as leaks of internal resource may be provided.

In addition, according to one embodiment of the present invention, in case a user who accesses an in-house resource management server 40 unintentionally performs a malicious behavior, when the malicious behavior is detected, a solution for restoring a reduced confidence level of a user may be provided as feedback information, so that an unintentional internal threatener may be prevented from occurring, and a security effect on in-house resources may be further enhanced.

Although the above description has been made with reference to specific embodiments and drawings, various modifications and changes can be made by a person having ordinary skill in the art from the above description.

Meanwhile, referring to FIG. 6, FIG. 6 shows one example of an internal configuration of a computing device according to one embodiment of the present invention. In the following description, redundant descriptions of the embodiments corresponding to the above descriptions of FIGS. 1 to 5 will be omitted.

As shown in FIG. 6, a computing device 10000 may at least include at least one processor 11100, a memory 11200, a peripheral interface 11300, an input/output (I/O) subsystem 11400, a power circuit 11500, and a communication circuit 11600. In this case, the computing device 10000 may correspond to a user terminal A connected to a tactile interface device, or correspond to a computing device B described above.

The memory 11200 may include, for example, a high-speed random access memory, a magnetic disk, an SRAM, a DRAM, a ROM, a flash memory, or a non-volatile memory. The memory 11200 may include a software module, an instruction set, or other various data required for an operation of the computing device 10000.

In this case, access to the memory 11200 from other components such as the processor 11100 or the peripheral interface 11300 may be controlled by the processor 11100.

The peripheral interface 11300 may couple an input and/or output peripheral device of the computing device 10000 to the processor 11100 and the memory 11200. The processor 11100 may execute the software module or the instruction set stored in the memory 11200 to perform various functions for the computing device 10000 and process data.

The I/O subsystem 11400 may couple various input/output peripheral devices to the peripheral interface 11300. For example, the I/O subsystem 11400 may include a controller for coupling the peripheral device, such as a monitor, a keyboard, a mouse, a printer, or a touch screen or a sensor if necessary, to the peripheral interface 11300. According to another aspect, input/output peripheral 1 devices may be coupled to the peripheral interface 11300 without passing through the I/O subsystem 11400.

The power circuit 11500 may supply a power to all or some of the components of the terminal. For example, the power circuit 11500 may include a power management system, at least one power source such as a battery or an alternating current (AC), a charging system, a power failure detection circuit, a power converter or inverter, a power status indicator, or any other components for generating, managing, or distributing a power.

The communication circuit 11600 may use at least one external port to enable communication with other computing devices.

Alternatively, as described above, the communication circuit 11600 may include an RF circuit, if necessary, to transmit and receive an RF signal, which is also known as an electromagnetic signal, thereby enabling the communication with other computing devices.

The above embodiment of FIG. 6 is merely one example of the computing device 10000, and the computing device 10000 may have a configuration or arrangement that omits some of the components shown in FIG. 6, further includes an additional component that is not shown in FIG. 6, or combines at least two components. For example, a computing device for a communication terminal in a mobile environment may further include a touch screen, a sensor, or the like in addition to the components shown in FIG. 6, and the communication circuit 11600 may include a circuit for RF communication in various communication schemes (Wi-Fi, 3G, LTE, Bluetooth, NFC, Zigbee, etc.). The components that may be included in the computing device 10000 may be implemented as hardware, software, or a combination of both hardware and software including at least one integrated circuit specialized in signal processing or an application.

The methods according to the embodiments of the present invention may be implemented in the form of program instructions that may be executed through various computing devices, and may be recorded in a computer-readable medium. In particular, a program according to the present embodiment may be configured as a PC-based program or an application dedicated to a mobile terminal. An application to which the present invention is applied may be installed in a user terminal through a file provided by a file distribution system. For example, the file distribution system may include a file transmission unit (not shown) for transmitting the file according to a request from the user terminal.

The device described above may be implemented as a hardware component, a software component, and/or a combination of the hardware component and the software component. For example, the devices and components described in the embodiments may be implemented by using at least one general-purpose or special-purpose computer such as a processor, a controller, an arithmetic logic unit (ALU), a digital signal processor, a microcomputer, a field programmable gate array (FPGA), a programmable logic unit (PLU), a microprocessor, or any other device capable of executing and responding to an instruction. A processing device may execute an operating system (OS) and at least one software application executed on the operating system.

In addition, the processing device may access, store, manipulate, process, and generate data in response to the execution of the software. In some cases, one processing device has been described as being used for convenience of understanding. However, it will be appreciated by a person having ordinary skill in the art that the processing device may include a plurality of processing elements and/or a plurality of types of processing elements. For example, the processing device may include a plurality of processors or one processor, and one controller. In addition, other processing configurations such as a parallel processor are also possible.

The software may include a computer program, a code, an instruction, or a combination of at least one thereof, and may configure the processing device to operate as desired or instruct the processing device independently or collectively. In order for the software and/or data to be interpreted by the processing device or to provide an instruction or data to the processing device, the software and/or data may be permanently or temporarily embodied in any type of machine, component, physical device, virtual equipment, computer storage medium, or device. The software may be distributed over computing devices, which are connected through a network, so as to be stored or executed in a distributed manner. The software and data may be stored in at least one computer-readable recording medium.

The method according to the embodiment may be implemented in the form of a program instruction that may be executed through various computer devices, and may be recorded in a computer-readable medium. The computer-readable medium may include a program instruction, a data file, a data structure, and the like, alone or in combination with each other. The program instruction recorded in the medium may be specially designed and configured for the embodiment, or may be publicly known and available to a person having ordinary skill in the art of computer software. An example of the computer-readable recording medium includes magnetic media such as a hard disk, a floppy disk, and a magnetic tape, optical media such as a CD-ROM and a DVD, magneto-optical media such as a floptical disk, and a hardware device specially configured to store and execute a program instruction, such as a ROM, a RAM, and a flash memory.

An example of the program instruction includes a high-level language code that may be executed by a computer by using an interpreter or the like, as well as a machine language code generated by a compiler. The hardware device may be configured to operate as at least one software module to perform the operations of the embodiments, and vice versa.

Although the above description has been made with reference to specific embodiments and drawings, various modifications and changes can be made by a person having ordinary skill in the art from the above description. For example, even when the described techniques are performed in an order that is different from the described manner, and/or the described components such as systems, structures, devices, and circuits are coupled or combined in a form that is different from the described manner, or replaced or substituted by other components or equivalents, appropriate results may be achieved. Therefore, other implementations, other embodiments, and equivalents to the claims are also within the scope of the appended claims.

What is claimed is:

1. A dynamic access control system based on confidence levels of a user and a user terminal, which is implemented as a computing device including at least one processor and at least one memory for storing instructions that are executable by the processor, the dynamic access control system comprising:
an agent installed in the user terminal, and configured to collect a registry generated in the user terminal;
a confidence determination machine in which legitimate user information and legitimate user terminal information are registered, configured to perform identity authentication for the user and the user terminal, which request access to an in-house resource management server, and configured to perform verification on state information of the user terminal based on a security policy that is previously distributed to determine a confidence level when the identity authentication for the user and the user terminal is completed; and
a terminal management server configured to transmit a registry collection result from the agent to the confidence determination machine as the state information of the user terminal.

2. The dynamic access control system of claim 1, wherein the confidence determination machine determines whether to allow the access to the in-house resource management server based on the confidence level determined for the user terminal, such that the access to the in-house resource management server is allowed when the confidence level determined for the user terminal is greater than or equal to a preset threshold confidence level, and the access to the in-house resource management server is not allowed when the confidence level determined for the user terminal is less than the preset threshold confidence level.

3. The dynamic access control system of claim 2, wherein, when a request for the access to the in-house resource management server is received again from the user terminal that is not allowed to access the in-house resource management server, the confidence determination machine determines whether the confidence level of the user terminal has reached the preset threshold confidence level, and allows the access to the in-house resource management server when the confidence level of the user terminal is determined to be increased to satisfy the threshold confidence level.

4. The dynamic access control system of claim 3, wherein, when at least one access denial history is determined to exist as a result of checking an access history of the user terminal to the resource management server, the confidence determination machine requests additional authentication to the user terminal through an additional authentication server, and allows the user terminal that has completed the additional authentication to access the in-house resource management server.

5. The dynamic access control system of claim 1, wherein the confidence determination machine monitors an operation authorized to the user terminal after the user terminal accesses the in-house resource management server, and dynamically controls access authority to the in-house resource management server by reducing the confidence level of the user, which is predetermined in the user terminal, and expiring an access session to the in-house resource management server when a malicious behavior that violates the security policy is detected from the user terminal as a result of the monitoring.

6. The dynamic access control system of claim 1, wherein resources managed by the in-house resource management server have different confidence levels required for access depending on importance of the resources, and
the confidence determination machine determines whether the confidence level determined for the user terminal satisfies a confidence level required for access to one resource managed by the in-house resource management server so as to determine whether to allow the access when a request for the access to the one resource is received from the user terminal.

7. The dynamic access control system of claim 6, wherein, when the confidence level required for the access to the one resource has a higher value than the confidence level determined for the user terminal, the confidence determination machine does not allow the user terminal to access the one resource, and provides feedback information on a confidence level reduction factor to the user terminal that is not allowed to access the one resource.
